(19) United States
(12) Patent Application Publication
(10) Pub. No.: US 2010/0000483 A1
(43) Pub. Date: Jan. 7, 2010

(54) GASOLINE COMPOSITIONS

(76) Inventors: Lionel Clarke, Chester (GB); Alison Felix-Moore, Chester (GB); Jurgen Johannes Jacobus Louis, Hamburg (DE); Johanne Smith, Chester (GB)

Correspondence Address: SHELL OIL COMPANY, P O BOX 2463, HOUSTON, TX, 772522463, US

(21) Appl. No.: 12/496,048

(22) Filed: Jul. 1, 2009

(30) Foreign Application Priority Data
Jul. 2, 2008 (EP) 08159554.8

(51) Int. Cl. F02B 75/12; C10L 1/19

(52) U.S. Cl. 123/1 A; 44/401

(57) ABSTRACT

The present invention provides a method for decreasing the vapour pressure of a gasoline composition comprising admixing with a gasoline base fuel, from 0.5 to 30 vol. %, based on the overall gasoline composition, of ethyl valerate.

The present invention further provides a gasoline composition comprising a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component, and a method for controlling the vapour pressure of a gasoline composition comprising admixing with a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component.

The present invention further provides a method of operating a spark-ignition internal combustion engine, which method involves introducing into a combustion chamber of the engine a gasoline composition of the present invention.

### FIELD OF THE INVENTION

The present invention provides a method of adjusting the vapour pressure of a gasoline.

### BACKGROUND OF THE INVENTION

Ethyl valerate (also called ethyl pentanoate) is an ester commonly used in fragrance and flavouring applications.

JP57-115490-A1 (K.K. My-Skincare-Laboratories & Daikyu K.K.) discloses a kerosene deodoriser containing 1 kind or 2 or more kinds of lower fatty acid esters. Ethyl esters of valeric acid are included in the description as examples of possible lower fatty acid esters.

JP07-018269-A1 (Riken Koryo Kogyo K.K.) discloses fuel additives for suppressing the unpleasant odor characteristic of the fuel produced during incomplete combustion of said fuel. Ethyl pentanoate is disclosed as an ester useful as an odor suppressing additive, and gasoline compositions comprising 0.2 wt. % ethyl pentanoate are disclosed therein.

WO 01/36354 A1 (Ronyak) discloses compositions containing an odor-emitting hydrocarbonaceous material and an odor-suppressing amount of an aldehyde or a ketone, and a carboxylic acid ester. Ethyl valerate is disclosed as a carboxylic acid ester (Claim 18) and gasoline is disclosed as an odor-emitting hydrocarbonaceous material (Claim 9).

U.S. Pat. No. 2,228,662 and U.S. Pat. No. 2,334,006 (Standard Oil Company) discloses the addition of esters to motor fuels consisting essentially of branched chain paraffin hydrocarbons and having a relatively high anti-knock value to increase the anti-knock quality thereof.

The motor fuels to which the ester is added in both U.S. Pat. No. 2,228,662 and U.S. Pat. No. 2,334,006 is described as “consisting essentially of branched chain paraffin hydrocarbons, and more specifically describes the base fuel to which the ester is added as branched chain paraffin stocks comprising from five to twelve carbon atoms per molecule. U.S. Pat. No. 2,228,662 and U.S. Pat. No. 2,334,006 further describe that the base fuel of invention disclosed therein “usually is not alone a satisfactory motor fuel, for it is usually necessary that more volatile constituents, such as natural gasoline for example, be blended with it to make a finished fuel having the desired volatility or distillation curve, so that the fuel will have the desired characteristics relating to starting, acceleration, etc.”, and that such blending is objectionable because the more volatile blending stocks usually have relatively low anti-knock values.

U.S. Pat. No. 2,228,662 and U.S. Pat. No. 2,334,006 discloses that many of the esters “aid in producing a motor fuel having the desired volatility or distillation characteristics and reduce, and in some cases even eliminate, the proportion of volatile constituents”. U.S. Pat. No. 2,228,662 and U.S. Pat. No. 2,334,006 further discloses that esters containing four or five carbon atoms have “relatively high volatility”, and that esters containing three carbon atoms may be used “where higher volatility is desired” and esters containing six to seven carbon atoms per molecule where “relatively low volatility offers no problem”. However, the person skilled in the art would understand from U.S. Pat. No. 2,228,662 and U.S. Pat. No. 2,334,006 that the base motor fuels described therein have a volatility that is undesirably low for use as a motor fuel and that more volatile constituents need to be blended with it to make a finished fuel having suitable volatility.

Neither U.S. Pat. No. 2,228,662 or U.S. Pat. No. 2,334,006 quantify nor exemplify the effects on the volatility on the motor fuels disclosed therein caused by the addition of the esters disclosed therein.

The person skilled in the art would understand from the disclosures of U.S. Pat. No. 2,228,662 and U.S. Pat. No. 2,334,006 that esters may be used to increase the volatility of motor fuels having a volatility that is undesirably low, and that esters containing 3 carbon atoms increase the volatility of the motor fuel more than the esters containing six or seven carbon atoms.

US 2001/0034966 A1 discloses a method of reducing the vapour pressure of a C₃ to C₁₂ hydrocarbon-based motor fuel mixture containing 0.1 to 20% by volume of ethanol for conventional spark ignition internal combustion engines, wherein, in addition to an ethanol component (b) and a C₃ to C₁₂ hydrocarbon component (a), an oxygen-containing additive (c) selected from at least one of the following types of compounds: alcohol other than ethanol, ketone, ether, ester, hydroxy ketone, ketone ester, and a heterocyclic containing oxygen, is used in the fuel mixture in an amount of at least 0.05 by volume of the total fuel.

The vapour pressure of a fuel (e.g. Air Saturated Vapour Pressure (ASVP), Dry Vapour Pressure Equivalent (DVPE) or Reid Vapor Pressure (RVP)) is a measure of the volatility of the motor fuel. Fuels having a high vapour pressure may vaporise too readily in the fuel handling system, resulting in decreased flow to the engine and possibly stoppage through vapour lock. Conversely, fuels having low vapour pressure may not vaporise readily enough, resulting in difficulty starting (especially in winter conditions), slow warm-up and poor acceleration.

### SUMMARY OF THE INVENTION

The present invention provides a method for decreasing the vapour pressure of a gasoline composition comprising admixing with a gasoline base fuel, from 0.5 to 30 vol. %, based on the overall gasoline composition, of ethyl valerate.

The present invention further provides a method for controlling the vapour pressure of a gasoline composition comprising admixing with a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component.

The present invention further provides a gasoline composition having a Dry Vapour Pressure Equivalent (DVPE) in the range of from 30 to 110 kPa, comprising a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component.

The present invention yet further provides a method of operating a spark-ignition internal combustion engine, which method involves introducing into a combustion chamber of the engine a gasoline composition of the present invention.

### DETAILED DESCRIPTION OF THE INVENTION

We have found that, contrary to the teachings of U.S. Pat. No. 2,228,662 and U.S. Pat. No. 2,334,006, the use of ethyl valerate in modern gasoline fuel compositions actually causes a significant decrease in the vapour pressure of the finished fuel composition.

The gasoline base fuel contains a liquid hydrocarbon fuel and would normally be suitable for use in an internal combustion engine of the spark ignition (petrol) type. Gasolines typically contain mixtures of hydrocarbons boiling in the range from 25 to 230° C. (EN-ISO 3405) the optimal ranges and distillation curves typically varying according to climate and season of the year.

The hydrocarbons in a gasoline fuel may conveniently be derived in known manner from straight-run gasoline, synthetically-produced aromatic hydrocarbon mixtures, thermally or catalytically cracked hydrocarbons, hydrocracked petroleum fractions, catalytically reformed hydrocarbons or mixtures of these.

The research octane number (RON) of the gasoline base fuel may suitably be from 80 to 100, preferably from 90 to 100, more preferably from 94 to 100 (EN 25164). Its motor octane number (MON) may suitably be from 80 to 100, preferably from 84 to 100 (EN 25163).

It may have an olefin content of for instance from 0 to 20% v/v (ASTM D1319), an oxygen content of for instance from 0 to 5% w/w (EN 1601), an aromatics content of for instance from 0 to 50% v/v (ASTM D1319) and in particular a benzene content of at most 1% v/v.

The base fuel, and suitably also the overall fuel composition, preferably has a low or ultra low sulphur content, for instance at most 1000 ppmw (parts per million by weight), preferably no more than 500 ppmw, more preferably no more than 100, even more preferably no more than 50 and most preferably no more than even 10 ppmw. It also preferably has a low total lead content, such as at most 0.005 g/l, most preferably being lead free—having no lead compounds added thereto (i.e. unleaded).

Oxygenates, other than ethyl valerate, may also be incorporated in the gasoline base fuel; these include alcohols (such as methanol, ethanol, iso-propanol, tert-butanol and iso-butanol) and ethers (preferably ethers containing 5 or more carbon atoms per molecule, eg, methyl tert-butyl ether).

For example, the gasoline base fuels of the present invention may incorporate therein from 0 to 10% v/v of at least one oxygenate selected from methanol, ethanol, iso-propanol and iso-butanol.

A gasoline base fuel may include one or more additives such as anti-oxidants, corrosion inhibitors, ashless detergents, dehazers, dyes and synthetic or mineral oil carrier fluids. Examples of suitable such additives are described generally in U.S. Pat. No. 5,855,629. They can be added directly to the gasoline or can be blended before addition with one or more diluents, to form an additive concentrate. The (active matter) concentration of any additives present in the base fuel is preferably up to 1% w/w, more preferably in the range from 5 to 1000 ppmw, advantageously from 75 to 300 ppmw, such as from 95 to 150 ppmw.

The gasoline composition of the present invention is produced by admixing a gasoline base fuel with ethyl valerate and optionally a C₃₋₄ hydrocarbon component.

The ethyl valerate admixed with the gasoline base fuel in the present invention may be present in a concentration in the range of from 0.5 vol. % to 30 vol. %, based on the total volume of the gasoline composition. The ethyl valerate admixed with the gasoline base fuel in the present invention may be present in various concentration ranges having a lower limit of from 0.5 vol. %, preferably from 1 vol. %, more preferably from 2 vol. %, and an upper limit of at most 30 vol. %, preferably 25 vol. %, more preferably 20 vol. %, even more preferably 15 vol. %, based on the total volume of the gasoline composition (e.g. 0.5-30 vol. %, 0.5-25 vol. %, 0.5-20 vol. %, 0.5-15 vol. %, 1-30 vol. %, 1-25 vol. %, 1-20 vol. %, 1-15 vol. %, 2-30 vol. %, 2-25 vol. %, 2-20 vol. %, and 2-15 vol. %).

The optional C₃₋₄ hydrocarbon component of the gasoline compositions of the present invention comprises C₃ hydrocarbons, C₄ hydrocarbons and mixtures thereof. Preferably, the C₃₋₄ hydrocarbon component comprises propane, butane and mixtures thereof. Conveniently, butane gas may be used as the C₃₋₄ hydrocarbon component. The C₃ and C₄ hydrocarbons present in the optional C₃₋₄ hydrocarbon component are in addition to any C₃ and C₄ hydrocarbons that may be present in the gasoline base fuel.

The C₃₋₄ hydrocarbon component optionally admixed with the gasoline base fuel in the present invention may be present in a concentration in the range upwardly to 10 vol. %. When the optional C₃₋₄ hydrocarbon component is present in the gasoline composition of the present invention, it is preferably present in a concentration range having a lower limit of from 0.1 vol. %, preferably from 0.25 vol. %, more preferably from 0.5 vol. %, and an upper limit of at most 10 vol. %, preferably 7.5 vol. %, more preferably 5 vol. %, based on the total volume of the gasoline composition (e.g. 0.1-10 vol. %, 0.1-7.5 vol. %, 0.1-5 vol. %, 0.25-10 vol. %, 0.25-7.5 vol. %, 0.25-5 vol. %, 0.5-10 vol. %, 0.5-7.5 vol. % and 0.5-5 vol. %).

Whilst the concentration of the optional C₃₋₄ hydrocarbon component is typically in addition to any C₃ and C₄ hydrocarbons present in the gasoline base fuel, in one embodiment of the present invention, the amount of the C₃₋₄ hydrocarbon component in the gasoline composition is the total amount of C₃ and C₄ hydrocarbons present in the overall gasoline composition. Therefore, the gasoline composition of the present invention may conveniently comprises a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component. Conveniently, the total amount of C₃₋₄ hydrocarbon component may be present in the above gasoline composition (i.e. the combined total of the optional C₃₋₄ hydrocarbon component and any C₃ and C₄ hydrocarbons present in the base gasoline) in a concentration range having a lower limit of from 0.1 vol. %, preferably from 0.25 vol. %, more preferably from 0.5 vol. %, and an upper limit of at most 10 vol. %, preferably 7.5 vol. %, more preferably 5 vol. %, based on the overall gasoline composition (e.g. 0.1-10 vol. %, 0.1-7.5 vol. %, 0.1-5 vol. %, 0.25-10 vol. %, 0.25-7.5 vol. %, 0.25-5 vol. %, 0.5-10 vol. %, 0.5-7.5 vol. % and 0.5-5 vol. %).

When the gasoline composition of the present invention does not have the optional C₃₋₄ hydrocarbon component admixed therein, the vapour pressure of the gasoline composition of the present invention is decreased in comparison to the vapour pressure of the gasoline base fuel.

By decreasing, reducing or lowering the vapour pressure of the gasoline base fuel, it is meant that the numerical value of the vapour pressure (e.g. ASVP, DVPE or RVP) for the gasoline compositions produced by the method of the present invention is numerically decreased relative to the numerical value of the vapour pressure for the gasoline base fuel used in the preparation of the gasoline composition according to the present invention.

Therefore, the present invention also provides the use of ethyl valerate in a gasoline composition comprising a major proportion of gasoline base fuel for reducing the vapour pressure of the gasoline composition relative to the vapour pressure of the gasoline base fuel.

Since C₃ and/or C₄ hydrocarbons are highly volatile and have a tendency to increase the vapour pressure of gasoline, the addition of the C₃₋₄ hydrocarbon component advantageously allows a greater control of the vapour pressure of the gasoline composition. Therefore, when the gasoline composition of the present invention does have the optional C₃₋₄ hydrocarbon component admixed therein, the vapour pressure of the gasoline composition of the present invention can be controlled.

By controlling the vapour pressure of the gasoline composition, it is meant that the numerical value of the vapour pressure (e.g. ASVP, DVPE or RVP) for the gasoline compositions produced by the method of the present invention can be numerically decreased, have no numerical change, or numerically increased relative to the numerical value of the vapour pressure for the gasoline base fuel used in the preparation of the gasoline composition according to the present invention.

Preferably, the DVPE of the gasoline composition of the present invention is in the range of from 30.0 kPa to 110.0 kPa, more preferably in the range of from 40.0 kPa to 95.0 kPa, most preferably in the range of from 45.0 to 90.0.

The optimal vapour pressure of the gasoline compositions of the present invention will vary depending upon the climate and season of the year. For example, the optimal vapour pressure for gasoline compositions for use in hot climates would be lower than the optimal vapour pressure for gasoline compositions for use in cold climates, and the optimal vapour pressure for gasoline compositions for use in summer would be lower than the optimal vapour pressure for gasoline compositions for use in winter.

For example, summer blend gasoline compositions in Europe typically have a DVPE in the range of from 45.0 to 60.0, and winter blend gasoline compositions in Europe typically have a DVPE in the range of from 60.0 to 90.0.

Usefully, ethyl valerate can be admixed with gasoline base fuels having a vapour pressure that is above optimal for the climate or season, or is too high to meet local regulatory standards, in order to decrease the vapour pressure to be optimal for the climate or season or to meet local regulatory standards. For instance, ethyl valerate may be admixed with a seasonal gasoline formulated for use in the winter to provide a seasonal gasoline composition suitable for use in the summer.

Additionally, because gasoline compositions comprising ethyl valerate have a lower vapour pressure compared to the gasoline base fuel to which ethyl valerate has been added, the use of ethyl valerate in gasoline compositions allow the inclusion of highly volatile components in gasoline base fuels that would otherwise be prevented due to the effects on the vapour pressure of the gasoline base fuel.

Also, ethyl valerate and the optional C₃₋₄ hydrocarbon component can be admixed with gasoline base fuels having a vapour pressure that is above or below optimal for the climate or season, or is too high or too low to meet local regulatory standards, in order to decrease or increase the vapour pressure to be optimal for the climate or season or to meet local regulatory standards. Furthermore, ethyl valerate and the optional C₃₋₄ hydrocarbon component can be admixed with a gasoline base fuel already having an optimal vapour pressure in order to blend in to the gasoline composition excess C₃₋₄ hydrocarbons that may be produced at the refinery without causing adverse effect on the vapour pressure of the gasoline composition.

The present invention further provides a method of operating a spark-ignition internal combustion engine, which method involves introducing into a combustion chamber of the engine a gasoline composition according to the present invention.

The present invention will be further understood from the following examples, which illustrate the effects of ethyl valerate on the vapour pressure of a gasoline base fuel.

### EXAMPLES

The vapour pressures of the gasoline base fuels and gasoline compositions according to the present invention were tested in accordance with test method IP 394, using a SETAVAP 2 instrument.

The test involves injecting the sample (which has been pre-cooled to between 0° C. and 1° C. and air-saturated) into the test chamber, which is set to 37.8° C. +/−0.1° C. The pressure indicator reading is recorded every 60 s +/−5 s until 3 successive readings agree to within 0.1 kPa. The average (mean) of these 3 values is recorded as the ASVP (Air Saturated Vapour Pressure). The DVPE is then calculated from the ASVP using the equation detailed in test method IP 394.

Details of the gasoline blends are given in Table 1 below.

TABLE 1

| | Gasoline base | Ethyl Valerate |
|---|---|---|
| Example | fuel (% vol.) | (% vol.) |
| A * | A (100) | — |
| 1 | A (95) | 5 ^{a} |
| B * | B (100) | — |
| 2 | B (90) | 10 ^{b} |
| 3 | B (80) | 20 ^{b} |
| C * | C (100) | — |
| 4 | C (90) | 10 ^{c} |
| 5 | C (80) | 20 ^{c} |
| D * | D (100) | — |
| 6 | D (90) | 10 ^{c} |
| 7 | D (80) | 20 ^{c} |
| E * | E (100) | — |
| 8 | E (90) | 10 ^{c} |
| 9 | E (80) | 20 ^{c} |

* - not according to the invention
^{a} = Ethyl valerate supplied by Aldrich (99% grade)
^{b} = Ethyl valerate supplied by Aldrich (98% grade)
^{c} = Ethyl valerate supplied by Shanghai Pu Jie, China

Details of the gasoline base fuels used in the examples are given below.

Gasoline base fuel A is an unleaded gasoline base fuel (ULG-95) having the following characteristics; sulphur content (ISO 20884) 28 ppmw, aromatics content of 34.6% v/v and olefins content of 18% v/v (GC analysis; LTP/36), density at 15° C. (IP 365) 746.5 kg/m³, and distillation (IP 123): IBP 32.8° C., 10% 51.0° C., 50% 100.2° C., 90% 160.4° C. and FBP 203.0° C.

Gasoline base fuel B is an unleaded gasoline base fuel (ULG-95) having the following characteristics; sulphur content (ISO 20884) 30.7 ppmw, aromatics content of 35.02% v/v and olefins content of 14.64% v/v (GC analysis; LTP/36), density at 15° C. (IP 365) 742.6 kg/m³, and distillation (IP 123): IBP 30.2° C., 10% 46.1° C., 50% 102.1° C., 90% 159.5° C. and FBP 202.0° C.

Gasoline base fuel C is an unleaded gasoline base fuel (92.5 RON (ASTM D2699), 83.9 MON (ASTM D2700)) having the following characteristics; density at 15° C. (ISO 3675) 0.7431 kg/l, and distillation (IP 123): IBP 36° C., 10% 51.3° C., 50% 80.8° C., 90% 154.1° C. and FBP 193.1° C.

Gasoline base fuel D is an unleaded gasoline base fuel (94.2 RON (ASTM D2699), 84.3 MON (ASTM D2700)) having the following characteristics; density at 15° C. (ISO 3675) 0.7511 kg/l, and distillation (IP 123): IBP 35.4° C., 10% 53.0° C., 50% 86.4° C., 90% 157.6° C. and FBP 198.2° C.

Gasoline base fuel E is an unleaded gasoline base fuel (93.7 RON (ASTM D2699), 85.9 MON (ASTM D2700)) having the following characteristics; density at 15° C. (ISO 3675) 0.7534 kg/l, and distillation (IP 123): IBP 37.6° C., 10% 59.4° C., 50% 100.2° C., 90% 157.0° C. and FBP 196.0° C.

The DVPE for each of the gasoline blends detailed in Table 1 are given in Table 2 below.

TABLE 2

| | Ethyl valerate | DVPE (Kpa) |
|---|---|---|
| Example | (vol. %) | (IP 394) |
| A* | 0 | 67.7 |
| 1 | 5 | 64.9/63.4 |
| B * | 0 | 81.7 |
| 2 | 10 | 76.2 |
| 3 | 20 | 70.1 |
| C * | 0 | 56.5 |
| 4 | 10 | 54.9 |
| 5 | 20 | 51.0 |
| D * | 0 | 56.7 |
| 6 | 10 | 52.7 |
| 7 | 20 | 50.4 |
| E * | 0 | 46.6 |
| 8 | 10 | 44.4 |
| 9 | 20 | 42.1 |

It can be seen from Table 2 above that the addition of EV to base gasoline causes a decrease in DVPE relative to the gasoline base fuel, with increasing concentration of EV producing a greater decrease in the DVPE.

We claim:

1. A method for decreasing the vapour pressure of a gasoline composition comprising admixing with a gasoline base fuel, from 0.5 to 30 vol. %, based on the overall gasoline composition, of ethyl valerate.

2. The method of claim 1 wherein from 1 to 25 vol. %, based on the overall gasoline composition, of ethyl valerate is admixed with a gasoline base fuel.

3. The method of claim 2 wherein from 2 to 20 vol. %, based on the overall gasoline composition, of ethyl valerate is admixed with a gasoline base fuel.

4. A method for controlling the vapour pressure of a gasoline composition comprising admixing with a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component.

5. The method of claim 4 wherein from 1 to 25 vol. %, based on the overall gasoline composition, of ethyl valerate is admixed with a gasoline base fuel, and from 0.25 to 7.5 vol. % of a C₃₋₄ hydrocarbon component is admixed with a gasoline base fuel.

6. The method of claim 5 wherein from 2 to 20 vol. %, based on the overall gasoline composition, of ethyl valerate is admixed with a gasoline base fuel, and from 0.5 to 5 vol. % of a C₃₋₄ hydrocarbon component is admixed with a gasoline base fuel.

7. A gasoline composition having an Dry Vapour Pressure Equivalent (DVPE) in the range of from 30 to 110 kPa, comprising a gasoline base fuel, from 0.5 to 30 vol. %, based on the overall gasoline composition, of ethyl valerate, and from 0.1 to 10 vol. %, based on the overall gasoline composition, of a C₃₋₄ hydrocarbon component.

8. The gasoline composition of claim 7 comprising from 1 to 25 vol. %, based on the overall gasoline composition, of ethyl valerate and from 0.25 to 7.5 vol. % of a C₃₋₄ hydrocarbon component.

9. The gasoline composition of claim 8 comprising from 2 to 20 vol. %, based on the overall gasoline composition, of ethyl valerate and from 0.5 to 5 vol. % of a C₃₋₄ hydrocarbon component.

10. A method of operating a spark-ignition internal combustion engine, which method comprises introducing into a combustion chamber of the engine a gasoline composition of claim 7.

11. A method of operating a spark-ignition internal combustion engine, which method comprises introducing into a combustion chamber of the engine a gasoline composition of claim 8.

12. A method of operating a spark-ignition internal combustion engine, which method comprises introducing into a combustion chamber of the engine a gasoline composition of claim 9.
